(19) United States
(12) Patent Application Publication
(10) Pub. No.: US 2017/0248834 A1
(43) Pub. Date: Aug. 31, 2017

(54) Shape Shifting Reflector Umbrella Apparatus, Systems, and Methods

(71) Applicant: Sergio Alejandro Ortiz-Gavin, Van Nuys, CA (US)

(72) Inventor: Sergio Alejandro Ortiz-Gavin, Van Nuys, CA (US)

(21) Appl. No.: 15/594,724

(22) Filed: May 15, 2017

Related U.S. Application Data
(60) Provisional application No. 62/336,440, filed on May 13, 2016.

(51) Int. Cl. G03B 15/06; G02B 5/02; F21V 7/16

(52) U.S. Cl. CPC G03B 15/06; F21V 7/16; G02B 5/0284; F21V 7/06

(57) ABSTRACT

Light reflecting and directing umbrella apparatus and systems and methods utilizing such apparatus capable of shifting its shape for the purpose of manipulating and directing light from a light source in both a symmetrical and asymmetrical manner to illuminate a particular subject in a various manners for stage, studio, motion picture and still photography.

### CROSS-REFERENCE TO THE PRESENT DISCLOSURE

This U.S. Non-Provisional Patent Application claims the priority of U.S. Provisional Application No. 62/336,440, titled: “SHAPE SHIFTING REFLECTOR UMBRELLA APPARATUS, SYSTEMS, AND METHODS,” filed May 13, 2016 in the United States Patent and Trademark Office, the disclosure of which is hereby incorporated by reference in its entirety.

### FIELD OF THE PRESENT DISCLOSURE

This disclosure relates generally to light reflecting and directing umbrella apparatus, systems, and methods, and more specifically to a light reflecting and directing umbrella apparatus, systems, and methods capable of shape shifting for manipulating light from a light source both symmetrically and asymmetrically to illuminate a particular subject in various manners for stage, studio, motion picture and still photography.

### BACKGROUND OF THE RELATED ART

Legacy light reflecting and directing umbrellas comprise a plurality of radially oriented flexible ribs affixed to a parabolic shaped reflective skin configured such that, when expanded, the radially oriented flexible ribs are flexed and thereby exert structural tension to the parabolic shaped reflective skin to form a parabolic shaped reflective umbrella. A light source is placed at or near the focal point of the parabolic shaped reflective umbrella so that the umbrella can both reflect and direct the light from the light source to illuminate a particular subject in a desired manner for use in a wide range of photography and motion picture applications.

One example of a prior existing apparatus and system is U.S. Pat. No. 8,376,560 for a Collapsed Parabola Light Reflecting Umbrella Apparatus issued on Feb. 19, 2013. A further example is U.S. Pat. No. 8,194,337 direct to a Dynamic Alternating Panel Reflector Apparatus and issued on Jun. 5, 2012.

To create various illumination affects, photographers will often utilized various reflective umbrellas of different shapes and with different parabolic angles. If multiple photographic illumination affects are desired or if a photographer is experimenting with the lighting to find a particular desired illumination, it is not uncommon for several different reflective umbrellas to be utilized. Setting up, breaking down, and transporting several reflective umbrellas can be burdensome and costly in terms of both time and effort.

It would be advantageous if a single reflective umbrella could change its size, shape, and/or parabolic angle such that it could be adjusted to shift shape and create a wide range of different illumination affects, rather than requiring multiple different reflective umbrellas. There is a need for such apparatus, systems and methods that can be adjusted in terms of its size shape, and/or parabolic angle so a that a single adjustable reflective umbrella can create a wide variety of illumination affects.

The present disclosure distinguishes over the related art, providing heretofore unknown advantages as described in the following summary.

### SUMMARY OF EMBODIMENTS OF THE INVENTION

The present disclosure describes an improved lightweight reflector umbrella that is capable of adjusting its size, shape and parabolic angles, both symmetrically and asymmetrically, to create a wide range of illumination affects.

The inventive concepts and embodiments described herein address and mitigate the the above described challenges with legacy reflective umbrellas. The concepts and embodiments disclosed and described herein allow a single reflective umbrella to act as a wide range of light shaping tools. In some exemplar embodiments, the shape and diameter of the innovative light reflecting umbrella can be changed in a controlled manner by unzipping one or more zippers exposing additional panels of reflective material behind the zippers and allowing the umbrella to expand creating an parabolic cone with a wider angle. Alternatively to zippers, other reversible coupling devices may be utilized as well. In this disclosure the word zipper is used expansively to reference the coupling mechanism featuring interlocking teeth typically referred to as a zipper as well as any other reversible coupling mechanism.

In further examples, the umbrella configuration transitions from a narrow, deep parabolic cone (deep parabolic cone is abbreviated as DP) and increases the light dispersion to an ever increasing wider and wider beam angle. The user flattens out the umbrella transitioning from a deep parabolic cone into a shallow wide parabolic cone or beauty dish configuration.

The light reflected with the beauty dish configuration is generally between that of a direct flash and a soft box. This configuration gives the lighted image being photographed or filmed a wrapped, contrasted look. This “look” adds a more dramatic effect.

Geometrically, all legacy reflective umbrellas are shaped as symmetrical parabolas rotated about an axis to form symmetrical parabolic cone, which can be best described as symmetrical parabolic cones. The presently disclosed apparatus allows photographers and cinematographers to create “asymmetrical curve parabolas” by modifying opposite sides of the parabolic cone differently thereby creating unique asymmetrical parabolic cones with modified light dispersion patterns. The axis of symmetry where the light source is located and focused from spot to flood can now be modified inside the parabolic cone. At the latus rectum focal point (full spot) the focal point would be relatively on the axis of symmetry but as you focus the light source out to full flood the light source moves away from the axis of symmetry creating unique modified light dispersion patterns.

In further examples, a user can make the umbrella asymmetrical and configure the umbrella to be substantially oval shaped. The umbrella transitions from a standard parabolic cone shape known to skilled persons to a collapsed parabolic cone configuration, or alternatively the umbrella transitions from a standard reflector into an alternating panel umbrella.

Alternative embodiments include the use of reflector umbrella skins made from a reflective textile or made from other reflective materials known to skilled persons to reflect light. Such reflective materials include, but are not limited to, textiles, fabric materials and aluminum metalized foil laminated to a black polyester backing material, all of which are within the scope of the present invention.

### 1. First Shape Shifting Reflecting Umbrella Embodiment

This embodiment includes an umbrella with a reflecting surface that is positioned about a light source. The umbrella includes a center aperture that accommodates a light source and the structure for accommodating and positioning the light source. A plurality of zippers are configured with the reflecting surface and extend radially outward from near the center aperture toward the periphery of the reflecting skin surface. The zippers are sewn in place, glued in place, sonically welded in place or laced in place to the reflecting surface.

Zippers can be divided into three major parts: the tape, elements and slider. The slider joins or separates the elements when the zipper is opened or closed. Various types of sliders are available depending on use. The teeth, also known as the elements, are the parts on each side of a zipper that mesh, or engage, with each other when passed through the slider. When the left and the right side teeth are engaged they are called chain.

The zippers are placed so that a zipper is opened or unzipped by accessing the zipper from the inside of the umbrella, the reflecting surface side of the umbrella, and the zipper slider is pulled using the pull tab provided on each zipper. The additional panels or additional loops of material are behind the reflecting surface and stored behind the umbrella. The user unzips or opens the selected zippers and thereby deploys the additional panels or additional loops of material onto the reflecting surface side and allow the parabolic cone to expand at that location.

The user can then zip up or close the selected zippers by again pulling on the zipper slider using the zipper's pull tab to withdraw or reposition the additional panels or additional loops of material back to behind the reflecting surface of the umbrella, thereby contracting the parabolic cone once again.

This embodiment includes the use of different zippers because alternatively sized umbrellas may use different zippers. The embodiment includes the use of zippers ranging from big to small, from long to short and zippers made from a wide range of material from high strength plastic to stainless steel or bronze alloy. In many embodiments, the zipper can have a single pull tab for zipping and unzipping the zipper, other embodiments can have more than one pull tab to facilitate the zipping and unzipping process.

A preferred embodiment includes the use of high performance composite zippers that are rated for high temperatures. Exemplar of such zippers include the YKK® Vision® Nomex® Top Open zipper from the YKK Corporation of Japan although other zippers available from YKK® and other zippers from other manufacturers can be used.

### A. Example with Twenty-Four Zippers

Another exemplar embodiment includes the use of twenty-four zippers. Each zipper extends in a radial direction along the reflecting surface and equally spaced around the parabolic cone.

The reflecting surface is described as a parabolic reflecting surface but this embodiment includes the use of different shaped reflectors including non-parabolic reflectors that are well known to skilled persons. As one example, the length of a zipper on the embodiment extends roughly 90% of the length in the radial direction from the center aperture to the exterior edge of the reflecting surface.

The invention includes embodiments with zippers that are longer or greater than the 90% figure and includes zippers that are shorter or less than 90% and all of these zipper lengths are within the scope of the invention.

The numerical size of a reflector umbrella refers to the approximate diameter of the opened parabolic reflecting umbrella measured in centimeters in the examples below. This embodiment is capable of taking on the following configurations:

1. A size 77 umbrella with all zippers closed or zipped-up.

2. The size 77 umbrella with every other zipper unzipped is changed to a size 100 reflector umbrella.

3. The size 77 umbrella with every zipper unzipped is changed to substantially a size 120 reflector umbrella.

4. The size 77 umbrella with six zippers on top unzipped, six zippers on the bottom unzipped and the zippers on each side (six on each side) closed or zipped up in an asymmetrical, oblong, cats-eye or egg-shaped configuration.

5. The size 77 umbrella in an asymmetrical light reflecting configuration with one-half of the zippers zipped up and one-half of the zippers unzipped (i.e. half zipped, half unzipped pattern).

6. The size 77 umbrella in an asymmetrical light reflecting configuration with one-half of the zippers zipped up and one-half of the zippers unzipped (i.e. half zipped, half unzipped pattern) for use with a side light utilizing a shield apparatus.

7. The size 77 DP umbrella with all zippers closed or zipped-up is one size that is a substantially deeper shaped parabola, with the designation “DP” referring to a deep parabola.

8. The size 77 DP reflector umbrella with every other zipper unzipped is changed to a size 120 reflector umbrella that is a substantially deeper shaped parabola.

9. The size 77 DP reflector umbrella with all zippers unzipped is changed to a size 145 reflector umbrella.

10. The size 77 DP reflector umbrella in an oval light reflecting configuration with six zippers unzipped and six zippers zipped up (i.e. repeating 6 open, 6 closed pattern).

11. The size 77 DP reflector umbrella in an asymmetrical light reflecting configuration with one-half of the zippers zipped up and one-half of the zippers unzipped (i.e. half zipped, half unzipped pattern).

12. The size 77 DP reflector umbrella in an asymmetrical light reflecting configuration (half zipped, half unzipped pattern) for use with a side light utilizing a shield apparatus.

### B. Example with A Plurality of Zippers

This embodiment includes the use of a plurality of zippers and includes the use of, for example, twelve zippers arranged along the reflecting surface of the umbrella. In one example embodiment, the plurality of zippers may be arranged to extend in a radial direction, may be of different lengths and may be symmetrically arranged along the reflecting surface or may be asymmetrically arranged on the reflecting surface.

### C. Alternative Examples with Apparatus for Connecting

This embodiment includes the use of a hook and loop connector well known to skilled persons instead of one or more of the standard zippers. Alternatives also include different apparatus for connecting, including zippered connectors and include hook and loop systems, buttons, laces, straps, hooks and snap connectors known to persons skilled in the art.

### D. Alternative Examples

In further examples, the deployment of the additional panels or additional loops of material increases the reflecting surface area by a factor of two or more. In still further examples, the deployment of the additional panels or additional loops of material increases the reflecting surface area by 100%.

For the exemplary parabolic reflector embodiments illustrated in the drawings, the reflector is comprised of twenty-four panels. Other, embodiments of the invention may be constructed with and utilize more or less than twenty-four panels.

In one embodiment, the additional panel or additional loop of material is substantially the same size and same surface area as the panel on the reflecting surface. Thus, when the additional panel or additional loop of material is unzipped and deployed in this embodiment, the surface area of the panel is doubled or increased by substantially 100%.

Further embodiments include different sizes and surface areas for the additional panel or additional loop of material so that the reflecting surface panel area is adjusted or increased by different amounts and different percentages and all of these alternative embodiments are within the scope of the invention.

In further embodiments, the zippered sections are adjustably configured to be asymmetrical or alternatively arranged. For these exemplary embodiments, one panel of the reflecting surface can be fully unzipped so that the panel size is approximately doubled or increased by substantially 100%. One of the adjacent panels is partially unzipped so that the adjacent panel size is increased by approximately 50%. Other and different asymmetrical or alternative arrangements are within the scope of the invention.

For one exemplary embodiment with twenty-four panels with one of the panels fully unzipped and the additional panel or additional loop of material deployed, the reflecting umbrella increases in size by a factor of 1.042, or in other words, the reflecting umbrella becomes approximately 1.042 times bigger or 4.2% bigger or 1/24^{th} bigger.

For another exemplary embodiment with the reflecting umbrella having a diameter of 100 centimeters, and all of the panels are unzipped and the additional panels or additional loops of material are deployed, the reflecting umbrella increases in diameter to substantially 200 centimeters. Other and additional panel sizes and thus adjustments and increases in the diameter of a reflecting umbrella are within the scope of the invention.

### 2. Additional Shape Shifting Reflecting Umbrella Embodiments

An alternative embodiment utilizes a plurality of zippers configured on the backside of the umbrella behind the reflecting surface so that the zipper is accessed and zipped or unzipped from the backside of the umbrella. In this embodiment, the additional panels or additional loops of material are positioned on the inside of the umbrella on, and as part of, the reflecting surface.

The user unzips or opens the selected zippers on the backside of the umbrella by pulling on the zipper slider using the zipper's pull tab to reposition the additional panels or additional loops of material. However, the repositioning occurs on the inside of the umbrella and allows the reflecting surface to substantially flatten out and the reflecting surface changes shape.

This repositioning can be undone by zipping up the selected zippers, or partially zipping up one or more zippers. As will be appreciated by skilled persons, this embodiment allows the user to use a broad array of light shaping options.

This embodiment includes the use of a plurality of zippers and includes the use of, for example, twenty-four zippers, twelve zippers or a different number of zippers of different lengths. The zippers may be symmetrically arranged on the backside of the umbrella or may be asymmetrically arranged on the backside of the umbrella.

This embodiment further includes, instead of zippers, the use of different apparatus for connecting, including any kind of zippered connectors and includes hook and loop systems, buttons, laces, straps, hooks and snap connectors known to persons skilled in the art.

### 3. Additional Shape Shifting Reflecting Umbrella Embodiments

In an alternative embodiment, the additional panels or additional loops of material to be zipped up and deployed or unzipped and positioned are in different colors or in different color combinations permitting users to avail themselves of a wide arsenal of light shaping options.

In examples of this embodiment, one such additional panel or additional loop may be one color and other additional panels or loops a different color. The colors for the additional panels or loops include, but are not limited to, black, white, gold, silver and champagne. The color combinations for the additional panels or loops, include, but are not limited to, black and white, gold and white, silver and white and champagne and white.

An additional panel or additional loop may itself be a variety of colors or a mixture of colors. A single additional panel or loop may be of the same or different color as the adjoining panel and various color combinations with alternating colors and patterns are within the scope of the invention. Further examples of this embodiment include the use of sequins secured onto the additional panel or additional loop.

Further advantages and exemplary embodiments of the invention will be apparent to persons skilled in the art from the drawings and description set forth herein.

A primary objective inherent in the above described method and apparatus is to provide advantages not taught by the prior art.

Another objective is to provide an innovative buoyant apparatus designed to be Lightweight and low profile so that it can be worn or carried while performing routine low risk behaviors without causing excessive interference or discomfort.

A further objective is to provide an effective water emergency safety apparatus that is

capable of providing buoyancy and thermally insulating an individual from the water temperature thereby reducing the risk of hypothermia or death while awaiting rescue.

A still further objective is to provide a water emergency safety apparatus that is easy to board when fatigued, injured, or wearing other safety equipment, thereby increasing the chance that a distressed individual can properly utilize the apparatus and survive a water related emergency.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE DRAWINGS

FIG. 1 illustrates an example embodiment of the shape shifting reflector umbrella apparatus.

FIG. 2 is a side elevation view of an example embodiment of the shape shifting reflector umbrella apparatus in a narrow angle parabolic cone configuration.

FIG. 3 is another side elevation view of an example embodiment of the shape shifting reflector umbrella apparatus wide angle parabolic cone configuration.

FIG. 4 is a demonstrative section view taken along the designated section line 4 in FIG. 2.

FIG. 5 is a demonstrative section view taken along the designated section line 5 in FIG. 1.

FIG. 6 is a section view taken along lines 6-6 of FIG. 1 illustrating one embodiment of the shape shifting reflector umbrella apparatus with a zipper.

FIG. 7 is a partial view illustrating an embodiment of the shape shifting reflector umbrella apparatus with the zipper shown in FIG. 6.

FIG. 7A shows a partial view of an embodiment illustrating the use of three dimensional effects from configuring a partially unzipped zipper or zippers.

FIG. 7B shows a partial perspective view of an embodiment also illustrating the three dimensional effects from configuring a partially unzipped zipper or zippers.

FIG. 7C shows another partial view of an embodiment illustrating the three dimensional effects from configuring a partially opened connector apparatus.

FIG. 8 illustrates another example embodiment of the shape shifting reflector umbrella apparatus.

FIG. 9 shows another example embodiment of the shape shifting reflector umbrella apparatus.

FIG. 10 is a section view taken along lines 10-10 of FIG. 8 illustrating the embodiment of the shape shifting reflector umbrella apparatus shown in FIG. 8.

FIG. 11 is a section view taken along lines 11-11 of FIG. 9 illustrating the embodiment of the shape shifting reflector umbrella apparatus shown in FIG. 9.

FIG. 12 illustrates another example embodiment of the shape shifting reflector umbrella apparatus with a light source and the supporting focusing tube for the light source.

### DETAILED DESCRIPTION OF EMBODIMENTS OF THE INVENTION

The above described drawing figures illustrate an exemplary embodiment of the joint apparatus and its method of use in at least one of its preferred, best mode embodiments, which is further defined in detail in the following description. Those having ordinary skill in the art may be able to make alterations and modifications to what is described herein, without departing from its spirit and scope of the disclosure. Therefore, it must be understood that what is illustrated is set forth only for the purposes of example and that it should not be taken as a limitation in the scope of the present apparatus and method of use.

Described now in detail is a light reflecting and directing umbrella apparatus, systems, and methods capable of shape shifting for manipulating light from a light source both symmetrically and asymmetrically to illuminate a particular subject in a various manners for stage, studio, motion picture and still photography.

Reference is made to the Figures and it is understood that the following description is exemplary of embodiments of the invention and it is apparent to skilled persons that modifications are possible without departing from the inventive concepts herein described.

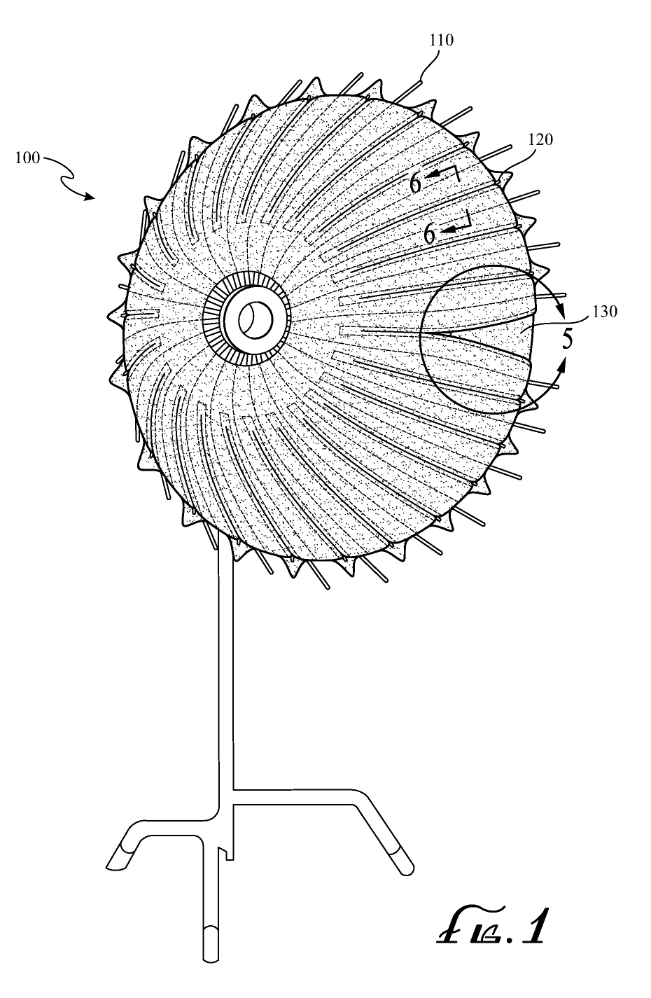

FIG. 1 illustrates an embodiment of the shape shifting reflector 100 umbrella apparatus with twenty-four zippers 120 configured with the reflecting surface of the umbrella. The reflector umbrella apparatus 100 accommodates a light source and accommodates a support for the light source and the entire assembly is supported by a conventional stand or other structures known to skilled persons. In this embodiment, the zippers 120 extend radially outward to the periphery of the reflecting surface as shown in FIG. 1.

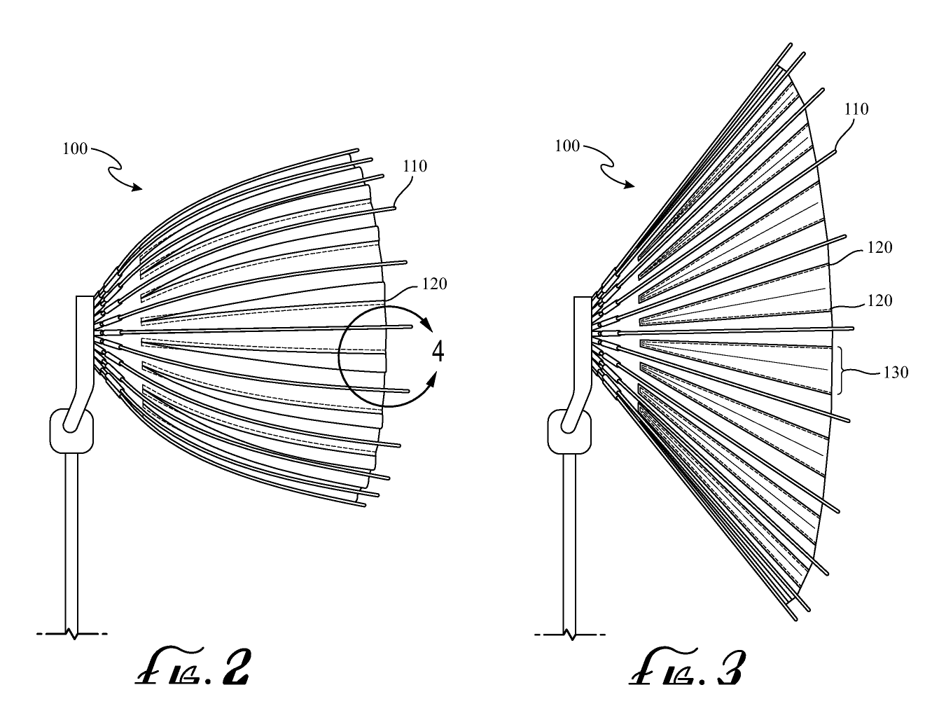

FIG. 2 shows a side elevation view of an example embodiment of the shape shifting reflector umbrella apparatus 100 from FIG. 1 with the zippers 120 all zipped up or closed.

FIG. 3 is another side elevation view of an example embodiment of the shape shifting reflector umbrella apparatus 100 illustrating a configuration with all zippers 120 unzipped or open.

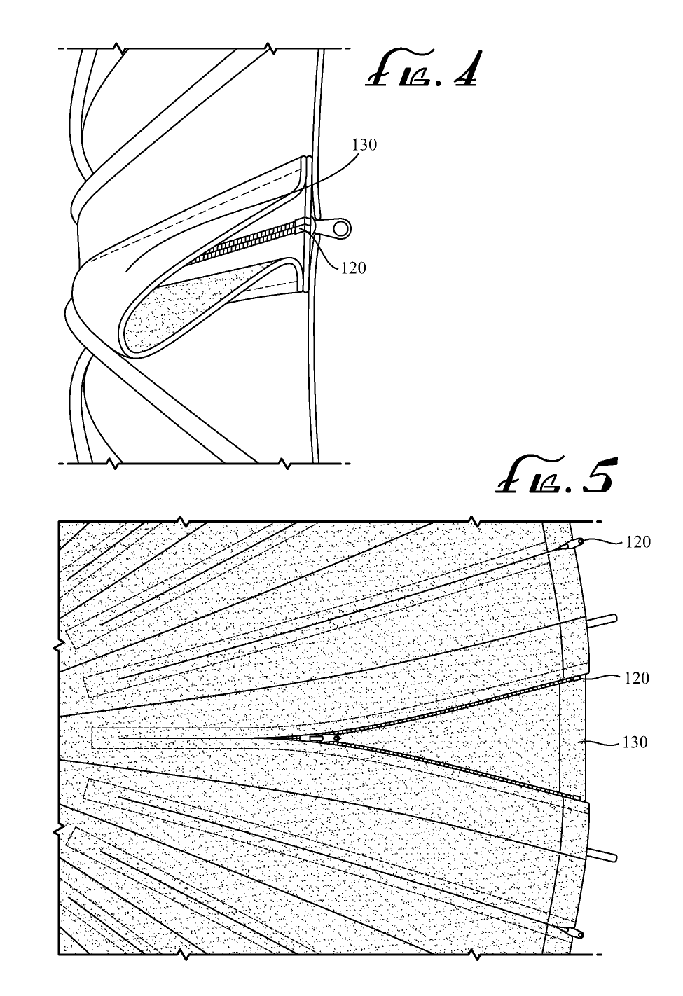

FIG. 4 shows one embodiment 100 with an additional panel or additional loop of reflective material 130 behind the reflecting surface and behind the umbrella 100 and the zipper 120 is zipped up or closed. FIG. 4 illustrates also that a zipper 120 has a pair of cover flaps 130 configured with the reflective surface of the umbrella to substantially cover over the zipper 120 to enhance the reflective properties of the umbrella 100.

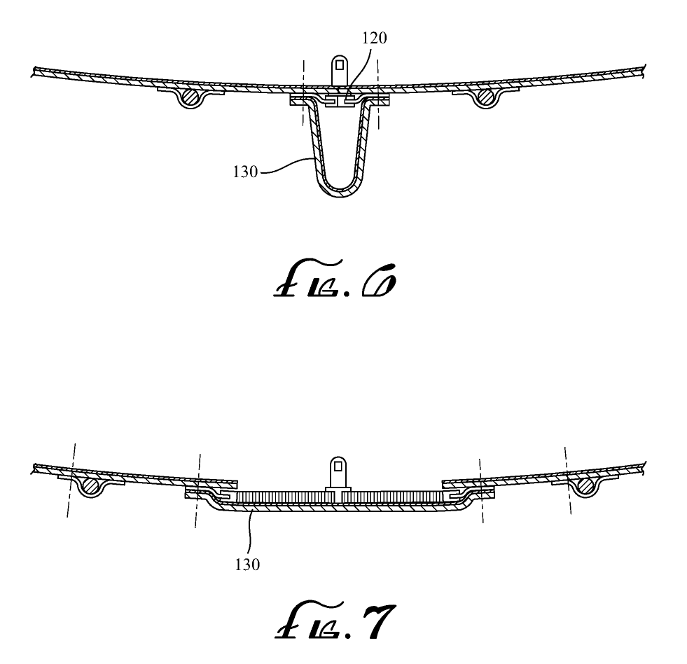

FIG. 5 shows an embodiment 100 with the zipper 120 partially unzipped or partially open. FIG. 5 also illustrates the cover flaps for each of the zippers 120. In the embodiment in FIG. 5, a part of the additional panel or additional loop of reflective material is utilized on the inside of the umbrella 100 with the umbrella's reflective surface. In examples of the embodiment in FIG. 5, the additional panel or additional loop of reflective material 130 is may be one color different from the color of the reflective surface.

In a further example referring to FIG. 5, the colors for the additional panel or loop 130 include, but are not limited to, black, white, gold, silver and champagne while the reflective surface is a contrasting color or contrasting colors.

Further examples include a configuration 100 where an additional panel or loop 130 is a different color than the adjoining panel or portion of the reflecting surface and various color combinations with alternating colors and patterns are within the scope of the invention.

In further examples, the additional panels or loops 130 may be a combination of colors including, but are not limited to, black and white, gold and white, silver and white and champagne and white and these examples are within the scope of the invention.

FIG. 6 illustrates an embodiment with the zipper 120 zipped up or closed and the additional panel 130 or additional loop of reflective material 130 is behind the reflecting surface and behind the umbrella.

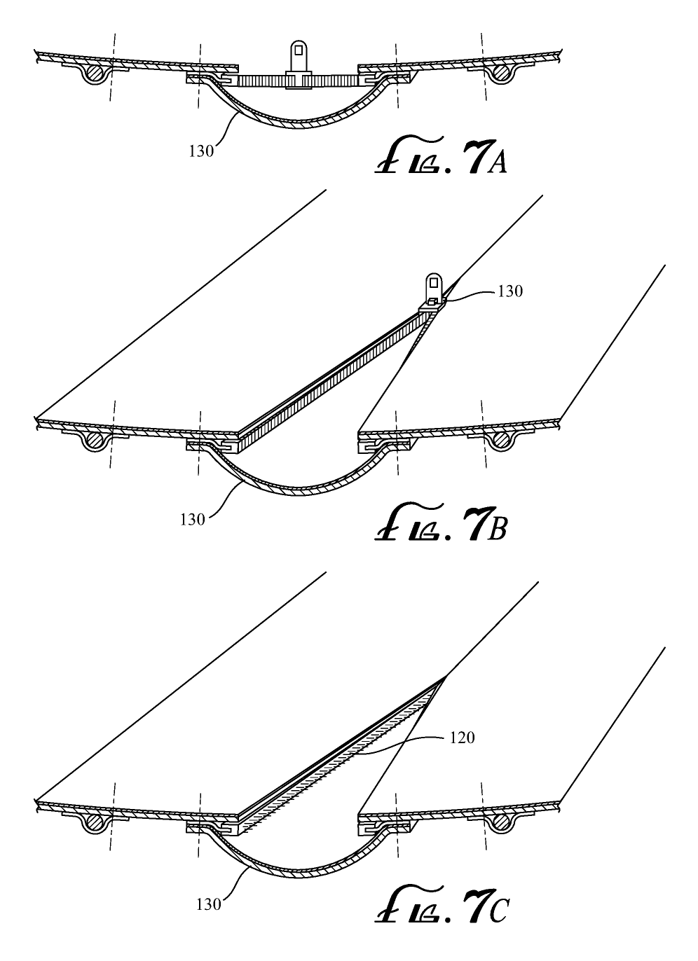

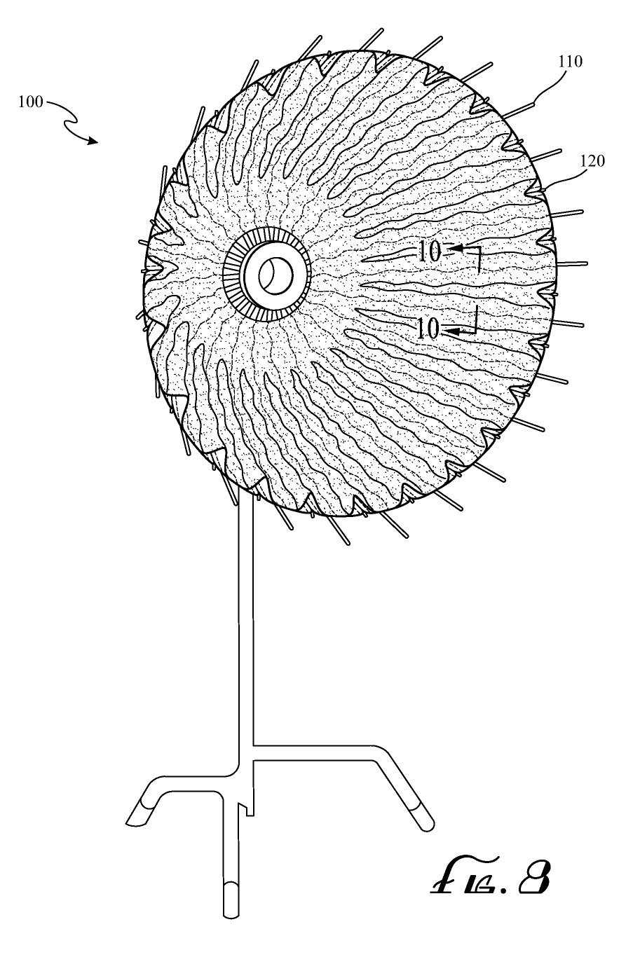

FIG. 7 illustrates an embodiment 100 with a zipper 120 unzipped or open and the additional panel 130 or additional loop of reflective material 130 is exposed inside of the umbrella 100 with the reflecting surface.

FIG. 7A illustrates one embodiment 100 where a zipper 120 is partially unzipped or partially opened, and thus, the additional panel 130 or additional loop of reflective material 130 is used in an exemplary three dimensional configuration in conjunction with the reflective surface of the umbrella 100.

FIG. 7B shows a partial perspective view of one embodiment 100 illustrating the three dimensional effects from configuring a partially unzipped zipper or zippers 120n. FIG. 7C shows another perspective view of an alternative embodiment 100 illustrating the three dimensional effects from configuring a partially opened connector apparatus 120 to open and close a panel on the reflecting surface 130.

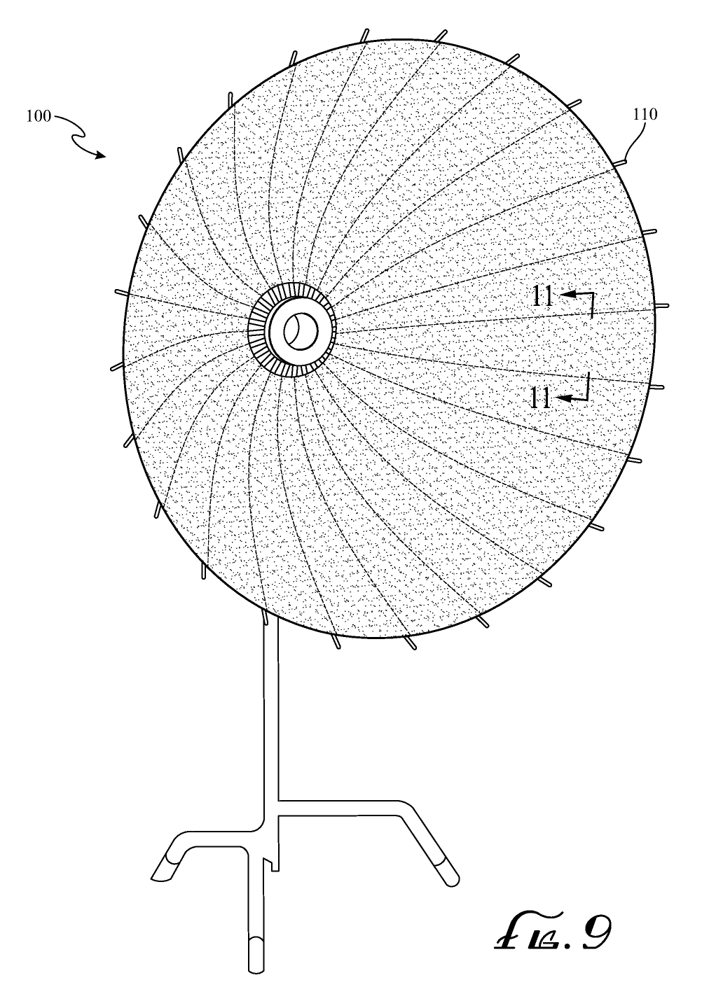

FIG. 8 illustrates an embodiment 100 with a plurality of zippers 120 configured on the backside of the umbrella 100 behind the reflecting surface so that each of the zippers 120 is accessed and zipped or unzipped from the backside of the umbrella 100. FIG. 8 illustrates the additional panels 130 or additional loops of material 130 positioned on the inside of the umbrella 100 on, and as part of, the reflecting surface.

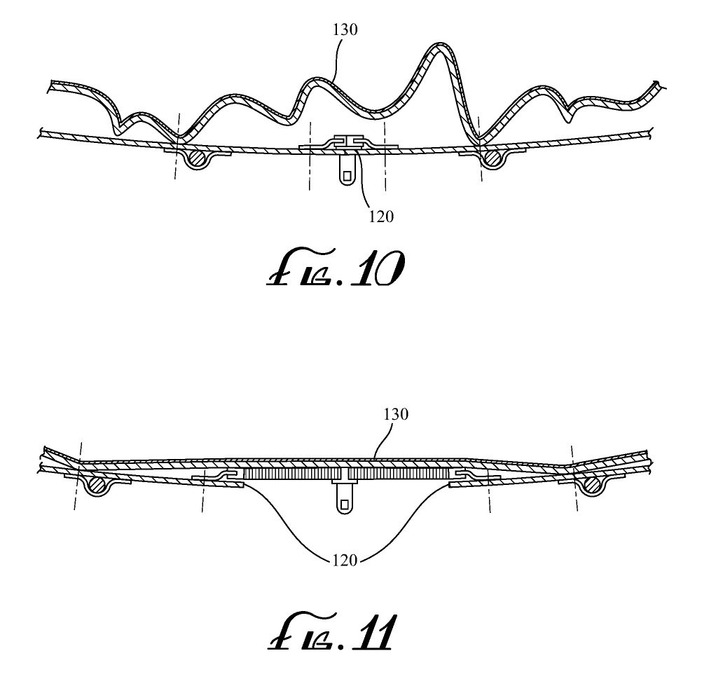

FIG. 9 illustrates the embodiment of FIG. 8 with the zippers 120 unzipped or opened. In this example embodiment 100, the additional panels or additional loops of material positioned on the inside of the umbrella 100 as shown in FIG. 8 and FIG. 10 now flatten out to form an altered shape for the reflecting surface of the umbrella 100 compared to the reflecting surface in FIG. 8.

FIG. 10 illustrates the embodiment in FIG. 8 with the zipper 120 zipped up or closed and one example of the configuration of the reflecting surface.

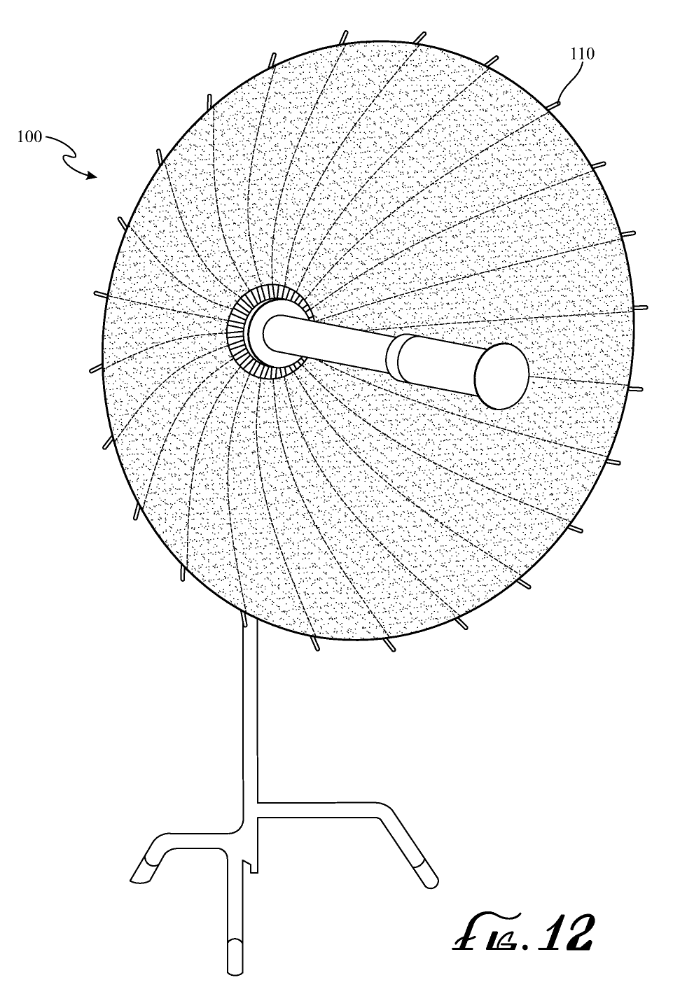

FIG. 11 shows the embodiment in FIG. 9 with the zippers 120 unzipped or opened so that the reflecting surface 130 flattens out.

FIG. 12 illustrates one example embodiment of the shape shifting reflector umbrella apparatus 100 showing one use of the apparatus with a light source and the supporting focusing tube for the light source.

While the present invention has been described with regards to particular embodiments, it is recognized that additional variations of the present invention may be devised by persons skilled in the art without departing from the inventive concepts disclosed herein

The enablements described in detail above are considered novel over the prior art of record and are considered critical to the operation of at least one aspect of the apparatus and its method of use, and to the achievement of the above-described objectives. The words used in this specification to describe the instant embodiments are to be understood not only in the sense of their commonly defined meanings, but to include by special definition in this specification: structure, material, or acts beyond the scope of the commonly defined meanings. Thus, if an element can be understood in the context of this specification as including more than one meaning, then its use must be understood as being generic to all possible meanings supported by the specification and by the word(s) describing the element.

The definitions of the words or drawing elements described herein are meant to include not only the combination of elements which are literally set forth, but all equivalent structures, materials or acts for performing substantially the same function in substantially the same way to obtain substantially the same result. In this sense it is therefore contemplated that an equivalent substitution of two or more elements may be made for any one of the elements described and its various embodiments, or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, substitutions, now or later known to one with ordinary skill in the art, are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A reflector umbrella apparatus, apparatus comprising:
a reflector skin;
a plurality radially oriented flexible ribs, affixed to said reflector skin and providing physical structure to said skin;
at least one radially positioned zipper;
a least one panel of material located adjacent said zipper such that when zipper in the zipper configuration said panel of material is in a folded configuration and when said zipper is in the unzipped configuration said panel of material is in a unfolded taught configuration.
